(19) United States
(12) Patent Application Publication
(10) Pub. No.: US 2024/0280999 A1
(43) Pub. Date: Aug. 22, 2024

(54) MOVABLE PLATFORM CONTROL METHOD AND APPARATUS, MOVABLE PLATFORM, AND STORAGE MEDIUM

(71) Applicant: SZ DJI TECHNOLOGY CO., LTD., Shenzhen (CN)

(72) Inventors: Wenliang GAO, Shenzhen (CN); Yi LIN, Shenzhen (CN); Zhenfei YANG, Shenzhen (CN)

(73) Assignee: SZ DJI TECHNOLOGY CO., LTD., Shenzhen (CN)

(21) Appl. No.: 18/644,394

(22) Filed: Apr. 24, 2024

Related U.S. Application Data
(63) Continuation of application No. PCT/CN2021/129019, filed on Nov. 5, 2021.

(51) Int. Cl. G05D 1/243; B64U 10/14; B64U 30/29; B64U 101/30; G05D 109/25; G05D 111/10; G06T 7/55; H04N 23/90

(52) U.S. Cl. CPC G05D 1/2435; G06T 7/55; H04N 23/90; B64U 10/14; B64U 30/29; B64U 2101/30; G05D 2109/254; G05D 2111/10; G06T 2207/10032

(57) ABSTRACT

A method of controlling a movable platform includes obtaining depth information of a scene in a first direction based on a first image captured by a first sensor of the movable platform and a third image by a third sensor of the movable platform, respectively; obtaining depth information of a scene in a second direction based on a second image captured by a second sensor of the movable platform and the third image by the third sensor of the movable platform, respectively; and controlling movement of the movable platform in space based on the depth information of the scene in the first direction and the second direction. The first sensor, the second sensor and the third sensor are mounted on the movable platform at substantially a same level. The third sensor has a first and a second overlapping field of view with the first sensor and the second sensor, respectively.

### CROSS-REFERENCE TO RELATED APPLICATION

The present application is a continuation of International Application No. PCT/CN2021/129019, filed Nov. 5, 2021, the entire content of which being incorporated herein by reference in its entirely.

### TECHNICAL FIELD

The present application relates to the technical field of movable platforms, and more specifically, to a control method, an apparatus, a movable platform, and a computer-readable storage medium for a movable platform.

### BACKGROUND

With the development of technology, movable platforms such as drones, self-driving vehicles, unmanned logistics vehicles or automatic cleaning equipment are increasingly being put into use. Usually, the movable platform is equipped with various sensors, which can collect data on surrounding environment, and the movable platform can control its own movement based on the data collected by the sensors.

### SUMMARY

According to an aspect of embodiments of the present disclosure, a method of controlling a movable platform may comprise:
obtaining depth information of a scene in a first direction based on a first image captured by a first sensor of the movable platform and a third image by a third sensor of the movable platform, respectively;
obtaining depth information of a scene in a second direction based on a second image captured by a second sensor of the movable platform and the third image by the third sensor of the movable platform, respectively;
controlling movement of the movable platform in space based on the depth information of the scene in both the first direction and the second direction.
wherein the first sensor, the second sensor and the third sensor are mounted on the movable platform at substantially a same level;
the first sensor has a first overlapping field of view with the third sensor to form a first binocular system to observe the scene in the first direction of the movable platform; and
the second sensor has a second overlapping field of view with the third sensor to form a second binocular system to observe the scene in the second direction of the movable platform; the first direction being different from the second direction.

According to another aspect of embodiments of the present disclosure, a control apparatus for a movable platform may comprise a processor, a memory, and a computer program stored in the memory executable by the processor, the processor executing the computer program is configured to:
obtain depth information of a scene in a first direction based on a first image captured by a first sensor of the movable platform and a third image by a third sensor of the movable platform, respectively;
obtain depth information of a scene in a second direction based on a second image captured by a second sensor of the movable platform and the third image by the third sensor of the movable platform, respectively;
control movement of the movable platform in space based on the depth information of the scene in both the first direction and the second direction.
wherein the first sensor, the second sensor and the third sensor are mounted on the movable platform at substantially a same level;
the first sensor has a first overlapping field of view with the third sensor to form a first binocular system to observe the scene in the first direction of the movable platform; and
the second sensor has a second overlapping field of view with the third sensor to form a second binocular system to observe the scene in the second direction of the movable platform; the first direction being different from the second direction.

According to another aspect of embodiments of the present disclosure, a control apparatus for a movable platform may comprise a processor, a memory, and a computer program stored in the memory executable by the processor, the processor executing the computer program is configured to:
obtain depth information of a scene based on an image captured by a first sensor of the movable platform and a second image by a second sensor of the movable platform, respectively;
control movement of the movable platform in space based on the depth information of the scene,
wherein the movable platform comprises a body and an arm, the arm extending outwardly from the body, the arm being configured to mount a power system for the movable platform;
the first sensor is oriented toward outside of the movable platform and the second sensor is oriented toward an underside of the movable platform;
a portion of the arm is disposed between a lower boundary of a field of view of the first sensor along a height direction of the movable platform and an upper boundary of a field of view of the second sensor along the height direction of the movable platform.

It should be understood that the above general description and the detailed description that follows are exemplary and explanatory only and do not limit the present application.

### BRIEF DESCRIPTION OF THE DRAWINGS

In order to explain the technical features of embodiments of the present disclosure more clearly, the drawings used in the present disclosure are briefly introduced as follow. Obviously, the drawings in the following description are some exemplary embodiments of the present disclosure. Ordinary person skilled in the art may obtain other drawings and features based on these disclosed drawings without inventive efforts.

FIG. 1A is a schematic architectural diagram of an unmanned aerial system according to one embodiment of the present application.

FIG. 1B is a schematic diagram of an unmanned aerial vehicle (UAV) carrying a vision sensor according to one embodiment of the present application.

FIG. 2A is a schematic diagram of a sensor carried by a movable platform according to one embodiment of the present application.

FIG. 2B is a flowchart of a method of controlling a movable platform according to one embodiment of the present application.

FIG. 3A is a schematic diagram of another UAV structure according to one embodiment of the present application.

FIG. 3B is a schematic diagram of sensing depth information within a field of view around a movable platform according to one embodiment of the present application.

FIG. 3C is a schematic diagram of a structure of a quadrotor UAV according to one embodiment of the present application.

FIG. 3D is a schematic diagram of one field of view range of a UAV sensor according to one embodiment of the present application.

FIG. 3E is a schematic view of the field of view range of another sensor of a movable platform according to one embodiment of the present application.

FIGS. 3F1 and 3F2 are schematic illustrations of the field of view range of the fourth sensor according to one embodiment of the present application, respectively.

FIG. 4A is a flowchart of a method of controlling a movable platform according to one embodiment of present application.

FIGS. 4B, 4C, and 4D are side, top, and front views, respectively, of an unmanned movable platform according to one embodiment of the present application.

FIG. 5 is a structural diagram of a control apparatus for a movable platform according to one embodiment of the present application.

FIG. 6 is a structural diagram of a removable platform according to one embodiment of the present application.

FIG. 7 is a structural diagram of a control apparatus for a movable platform according to one embodiment of the present application.

FIG. 8 is a structural diagram of a removable platform according to one embodiment of the present application.

### DETAILED DESCRIPTION

The technical solutions in the embodiments of the present disclosure will be clearly and completely described below in conjunction with the accompanying drawings in the embodiments of the present disclosure, and it is clear that the described embodiments are only a part of the embodiments of the present disclosure and not all of the embodiments. Based on the embodiments in the present disclosure, all other embodiments obtained by a person of ordinary skill in the art without making creative labor fall within the scope of protection of the present disclosure.

In order to control safe movement of the movable platform in space, the movable platform can observe information of scenery in the space through its own sensors, which include LiDAR, millimeter-wave radar, vision sensors, infrared sensors, or TOF (Time of flight) sensors, etc. In practice, based on different products, scenarios and requirements, different movable platforms have different types of sensors. In practice, based on different products, usage scenarios and needs, different movable platforms are equipped with different types of sensors.

The movable platform of this disclosure may refer to any device capable of being moved. Among other things, the moveable platform may include, but is not limited to, land vehicles, water vehicles, air vehicles, and other types of motorized means of delivery. As examples, the movable platforms may include passenger-carrying vehicles and/or Unmanned Aerial Vehicles (UAVs), etc., and movement of the movable platforms may include flying.

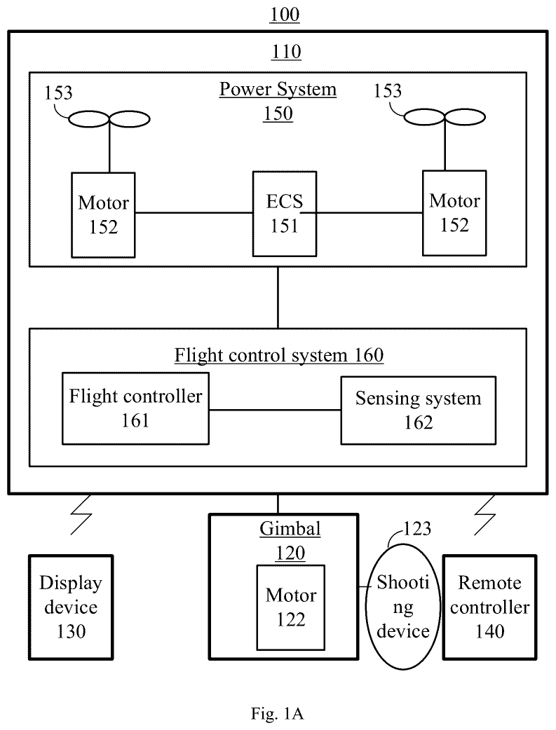

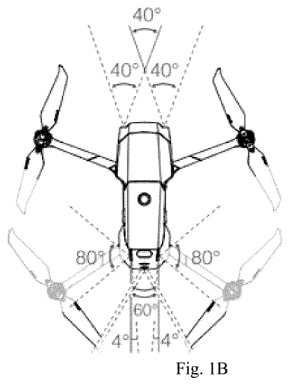

Taking a drone as an example, FIG. 1A is a schematic structural diagram of an unmanned aerial system of an embodiment of the present application. This embodiment is illustrated with a rotorcraft (rotary-winged drone) as an example. The unmanned aerial system 100 may comprise a drone 110, a display device 130, and a remote control device 140. The drone 110 may comprise a power system 150, a flight control system 160, a frame and a gimbal 120 carried on the frame. The UAV 110 may communicate wirelessly with the remote control device 140 and the display device 130.

The frame may include a fuselage or body and a tripod (also known as a landing gear). The fuselage may include a center frame and one or more arms connected to the center frame, the one or more arms extending radially from the center frame. The tripod is connected to the fuselage for supporting the UAV 110 during landing.

The power system 150 may include one or more electronic speed controllers (referred to as ESCs) 151, one or more propellers 153, and one or more power motors 152 corresponding to the one or more propellers 153, wherein the power motors 152 may be coupled between the electronic speed controllers 151 and the propellers 153, and the power motors 152 and the propellers 153 may be disposed on the arms of the UAV 110; the electronic speed controller 151 is used to receive a drive signal generated by the flight control system 160 and to provide a drive current to the power motors 152 in accordance with the drive signal to control the rotational speed of the power motors 152. The power motor 152 is used to drive the propeller to rotate, thereby providing power for the flight of the UAV 110 to enable the UAV 110 to achieve one or more degrees of freedom of movement. In some embodiments, the UAV 110 may rotate about one or more rotational axes. For example, the rotational axis may include a roll axis (Roll), a yaw axis (Yaw), and a pitch axis (pitch). It should be understood that the motor 152 may be a DC motor or an AC motor. Alternatively, the motor 152 may be a brushless motor or a brushed motor.

The flight control system 160 may include a flight controller 161 and a sensing system 162. One of the roles of the sensing system 162 is to be used to measure attitude information of the UAV, the attitude information being information about the position of the UAV 110 in space and information about its state, such as, for example, a three-dimensional position, a three-dimensional angle, a three-dimensional velocity, a three-dimensional acceleration, and a three-dimensional angular velocity. The sensor system may also have other roles, for example, it may be used to collect environmental observation data of the environment surrounding the UAV. The sensor system 162 may include, for example, one or more of the following: a gyroscope, an ultrasonic sensor, an electronic compass, an inertial measurement unit (IMU), a vision sensor, an infrared sensor, a TOF (Time of Flight) sensor, a lidar, a millimeter wave radar, a thermal imager, a global navigation satellite system, barometers, and so on. For example, the GNSS may be the Global Positioning System (GPS). The flight controller 161 is used to control the flight of the UAV 110, for example, the flight of the UAV 110 may be controlled based on attitude information measured by the sensing system 162. It should be understood that the flight controller 161 may control the UAV 110 in accordance with pre-programmed instructions or may control the UAV 110 by responding to one or more remote control signals from the remote control device 140.

The gimbal 120 may include a motor 122. The gimbal may be used to carry a load, such as a shooting device 123 and the like. The flight controller 161 may control the movement of the gimbal 120 via the motor 122. Optionally, as another embodiment, the gimbal 120 may also include a controller for controlling the movement of the gimbal 120 by controlling the motors 122. It should be understood that the gimbal 120 may be independent of the UAV 110 or may be part of the UAV 110. It should be understood that the motor 122 may be a DC motor or an AC motor. Alternatively, the motor 122 may be a brushless motor or a brushed motor. It should also be understood that the gimbal may be located at the top of the drone or may be located at the bottom of the drone.

The shooting device 123 may, for example, be a device for capturing images such as a camera or a video camera, and the shooting device 123 may be in communication with the flight controller and under the control of the flight controller. The shooting device 123 of this embodiment includes at least a light-sensitive element, which is for example a Complementary Metal Oxide Semiconductor (CMOS) sensor or a Charge-coupled Device (CCD) sensor. It will be appreciated that the shooting device 123 may also be fixed directly to the drone 110 so that the gimbal 120 may be omitted.

The display device 130 is located at the ground end of the unmanned flight system 100, can communicate with the UAV 110 wirelessly, and can be used to display attitude information of the UAV 110. Alternatively, images captured by the shooting device 123 may be displayed on the display device 130. It should be understood that the display device 130 may be a stand-alone device or may be integrated in the remote control device 140.

The remote control device 140 is located at the ground end of the unmanned aerial system 100 and can communicate with the UAV 110 wirelessly for remote maneuvering of the UAV 110.

It should be understood that the above naming of the components of the unmanned aerial system is for identification purposes only and should not be construed as a limitation of embodiments of the present application.

In some scenarios, such as consumer-grade UAVs and other movable platforms, visual sensors can be equipped to realize obstacle avoidance functions, which are usually realized using monocular vision systems and/or binocular vision systems. Among them, a monocular vision system typically uses a camera to acquire multiple images at different locations, and utilizes variations of the same object in multiple images to determine the depth information of the object. A binocular vision system, on the other hand, utilizes two cameras to form a binocular, acquires two images of the object under test from different positions based on the parallax principle and using an imaging device, and acquires three-dimensional geometric information of the object by calculating the positional deviation between the corresponding points of the images, i.e., the two cameras can be utilized to form a binocular to complete the perception of depth information of the scene in a certain direction. Based on this, the movable platform can acquire the images collected by the visual sensors to sense the depth information of the scene in the field of view of the sensor to ensure the obstacle avoidance function of the movable platform, so that the movable platform can move safely.

Among the functions of the visual perception system of the movable platform, the failure of perception obstacle avoidance will directly cause safety problems, and the effectiveness of perception obstacle avoidance is limited by the detection capability, detection accuracy and maximum detection distance of the perception scheme on one hand. On the other hand, the perception system configuration of the vehicle will also have a direct impact on robustness of the system. Taking UAVs as an example, obstacle avoidance, as a basic function, can bring about other enhancements to the user's operating experience, such as more assured use of intelligent functions, more flexible operation, smoother operating experience, etc., while ensuring that UAVs are safe to operate and do not fall. The main shortcoming of some visual perception UAVs in obstacle avoidance is that the effective range of obstacle avoidance is small, and there are many dead corners in the blind zone of perception, which lead to the possibility of failure of obstacle avoidance and falling of the UAV, and there is the possibility of not being able to fly intelligently due to the lack of obstacle avoidance ability.

FIG. 1B provides a schematic diagram of a UAV equipped with visual sensors according to an embodiment of the present application, the UAV in this embodiment, using a body coordinate system as an example for illustration, the body coordinate system is solidly connected to the UAV. The coordinate system conforms to the right hand law, the origin is at the center of gravity of the UAV, the X-axis points to the forward direction of the nose of the UAV, the Y-axis points to the right side of the UAV from the origin, and the direction of the Z-axis is determined according to the X and Y-axis by the right hand law. The UAV uses independent binocular vision systems in the forward and backward directions, and independent monocular vision systems in the left and right directions; from FIG. 1B, it can be seen that the scheme is designed with six sensors in the horizontal direction of the fuselage, but there are still many blind zones around the fuselage of the UAV, and the accuracies of the monocular vision systems in the left and right directions are slightly worse than those of the binocular vision systems.

Based on the limitation of the field of view of ordinary cameras, when using a binocular vision system to obtain depth information in the four directions of the circumferential view, two binocular cameras are required for each direction, i.e., each direction is configured with two cameras, the field of views of the two cameras overlap and are independently controlled by the binocular cameras in each direction. Therefore, to realize 3600 omnidirectional perception in the horizontal direction of the movable platform, the movable platform usually uses at least eight independently controlled cameras. In some scenarios, such as unmanned aircraft or automatic cleaning equipment and other movable platforms having requirements of miniaturization and low cost, how to ensure accuracy of obstacle avoidance at low cost is a technical problem that needs to be solved in the field of movable platforms.

Based on this, in one embodiment, the movable platform is designed to carry sensors with a larger field of view, and one sensor can have an overlap with the field of view of at least two sensors, i.e., one sensor can take into account at least two directions. Therefore, one sensor can form a binocular vision system with at least two sensors respectively, so that the number of visual sensors carried on the movable platform can be reduced, while at the same time guaranteeing a larger field of view coverage, and at the same time the accuracy of the depth information is also guaranteed by using the binocular vision system, so that the movable platform can be controlled to move safely. This is next illustrated by some embodiments.

In some embodiments, the movable platform may comprise: at least three sensors; of the at least three sensors, a first sensor, a second sensor, and a third sensor are substantially at the same level; the first sensor has a first overlapping field of view with the third sensor, the first overlapping field of view being used for observing a scene in a first direction of the movable platform; the second sensor and the third sensor having a second overlapping field of view, the second overlapping field of view being for observing a view in a second direction of the movable platform; the first direction being different from the second direction.

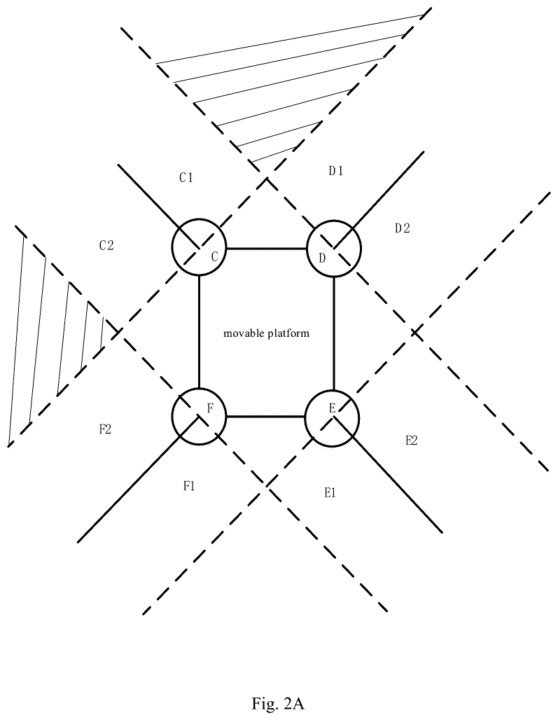

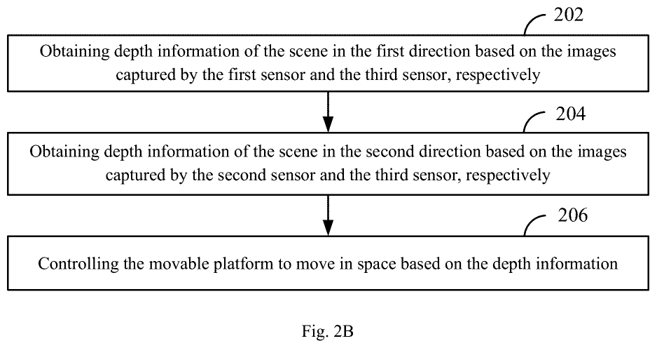

As shown in FIG. 2A, a schematic diagram of a sensor carried by a movable platform illustrated in the present application according to an exemplary embodiment. In the embodiment shown in FIG. 2A, as an exemplary embodiment, the platform body of the movable platform is a rectangle, and four sensors are carried at four angular positions of the rectangle, and each of the sensors has a field-of-view angle of 180°, and one sensor is associated with two sensors respectively of a binocular vision system. It can be understood that, in practice, the configuration of the movable platform has various forms, and the field of view angle, number, and carrying position of the sensors can be realized in a variety of ways, and a sensor can also constitute a plurality of binocular vision systems with more than two sensors; for example, the design can be synthesized according to the configuration of the movable platform, the field of view angle of the sensors, and the direction in which the movable platform needs to be observed, etc. This embodiment does not limit this. The present embodiments do not limit this.

As shown in FIG. 2A, the four sensors carried on the removable platform are sensor C, sensor D, sensor E, and sensor F. As an example, the first sensor, the second sensor, and the third sensor described in the preceding paragraph are exemplified by sensor D, sensor F, and sensor C. The sensor C has a field of view angle of 180°, and a main optical axis of the lens of the sensor C is the ray between the region C1 and the region C2, and its field of view range comprises region C1 and region C2 together. Similarly, the field of view ranges of the other three sensors are shown in FIG. 2A.

In one embodiment, the first sensor, second sensor and third sensor are in the same plane, adopting a body coordinate system, and the horizontal plane in which the movable platform body is located may be a plane formed by the x-axis and the y-axis, and the first sensor, second sensor and third sensor are set on the movable platform, and the plane in which the first sensor, second sensor and third sensor are located is parallel to the horizontal plane in which the body of the movable platform is located. Therefore, during movement of the movable platform, regardless of the direction of movement, the first sensor, second sensor and third sensor can observe the horizontal range of the movable platform.

The sensor C of the present embodiment can form a binocular vision system with the sensor D. The area where the region C1 in the field of view range of the sensor C crosses the region D1 in the field of view range of the sensor D, i.e., the first overlapping field of view where the two overlap, is schematized in FIG. 2A by using a diagonal line segment. The first overlapping field of view is for observing the scene in a first direction of the movable platform; the second overlapping field of view is for observing the scene in a second direction of the movable platform; the first direction is different from the second direction.

The sensor C and the sensor F form a binocular vision system, and the area where the area C2 in the field of view range of the sensor C crosses the area F2 in the field of view range of the sensor F, i.e., the second overlapping field of view where the two overlap, is schematized in FIG. 2A using a diagonal line segment.

As can be seen, the sensor C may constitute a binocular vision system with the sensor D and the sensor F, respectively; i.e., a portion of an image acquired by the sensor C and an image acquired by the sensor D, respectively, facing the same direction, may be used for binocular vision processing; and a portion of an image acquired by the sensor C and an image acquired by the sensor F, respectively, facing the same direction, may be used for binocular vision processing. That is, the sensor C can take both directions into account, and thus the image obtained by the sensor can be segmented into two parts, and the specific segmentation method can be determined according to the need. For example, it can be an equal segmentation into left and right parts in the example illustrated in FIG. 2A, or a part of the field of view overlapping with that of the other sensor can be used, such as segmentation of a first part of the field of view and a second part of the field of view, i.e., the part of FIG. 2A where the region C1 intersects with the region D1 and the region where region C2 intersects with region F2; or it may be a portion of the field of view overlapping with other sensors, such as a portion of the first field of view and a portion of the second field of view, and the like. Accordingly, a part of the image acquired by the sensor C forms a binocular image with a part of the image acquired by the sensor D, and another part of it forms a binocular image with a part of the image acquired by the sensor F.

Based on the above design, as shown in FIG. 2B, is a flowchart of a method of controlling a movable platform illustrated in the present application according to an exemplary embodiment, which may include the following steps:
In step 202, depth information of the scene in the first direction is obtained based on the images captured by the first sensor and the third sensor, respectively;
In step 204, depth information of the scene in the second direction is obtained based on the images captured by the second sensor and the third sensor, respectively;
In step 206, the movable platform is controlled to move in space based on the depth information.

In this embodiment, the third sensor forms a binocular vision system with the first sensor and the second sensor respectively, while the first field of view and the second field of view observe different first and second directions respectively, so that the movable platform can acquire depth information of the scenery in the first direction based on the images acquired by the first sensor and the third sensor respectively, and also acquire depth information of the scenery in the second direction based on the images acquired by the second sensor and the third sensor respectively, and based on the depth information, the movable platform can be controlled to move safely in the space. The way of obtaining the depth information may be obtained by using binocular vision.

In some examples, the number of sensors on the movable platform may be three or more, which may be determined according to the need in practical application. For example, the design may be comprehensively designed according to the configuration of the movable platform, the field of view angle of the sensors, the direction in which the movable platform is required to be observed, etc., which is not limited by the present embodiments. Wherein, at least three sensors in the movable platform are substantially in the same plane, whether other sensors are substantially in the same plane with the three sensors can be configured according to the needs, this embodiment does not limit this. Optionally, three sensors or more sensors are substantially in the same plane, and all sensors each may be the above mentioned “one sensor”. Each sensor may have the above “one sensor has an overlapping field of view with at least two sensors” feature, and the relevant realization methods are within the scope covered by this application.

Therein, the mounting positions of the first sensor, the second sensor, and the third sensor on the movable platform can be substantially in the same plane, and the mounting position of each sensor can be allowed to have a small deviation. In practice, the mounting positions of the at least three sensors on the movable platform can also be designed according to the configuration of the movable platform, the field of view angles of the sensors, the direction in which the movable platform needs to be observed, etc., and it is only necessary to place the first sensor, the second sensor, and the third sensor basically in the same plane, so that the three sensors are able to observe the environmental information around the movable platform on the plane.

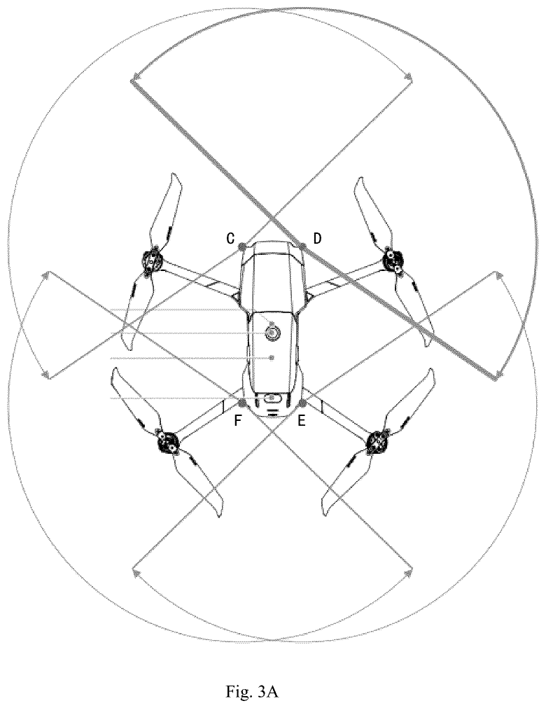

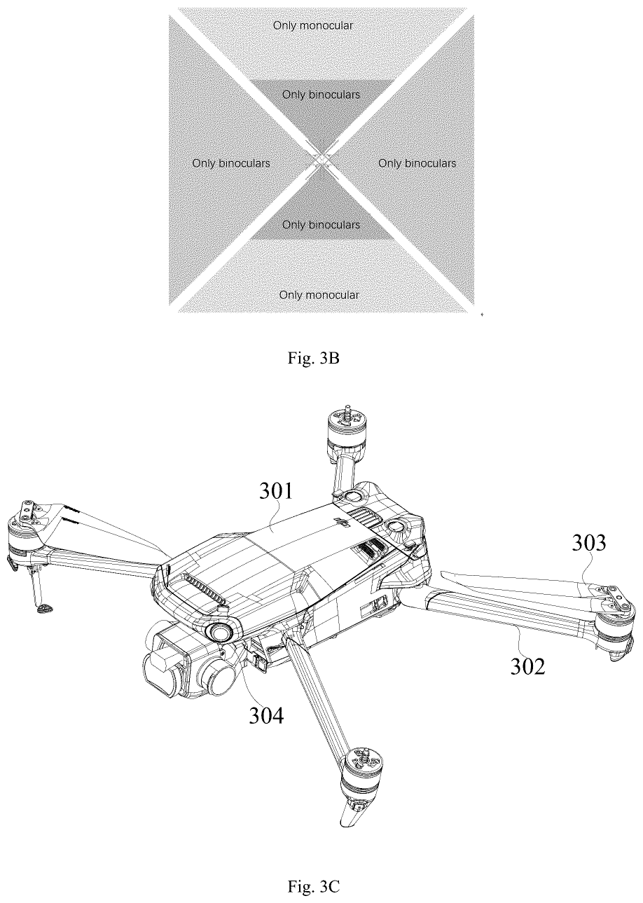

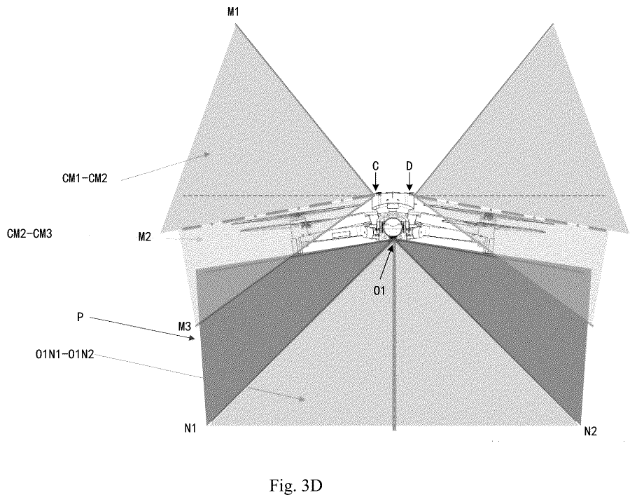

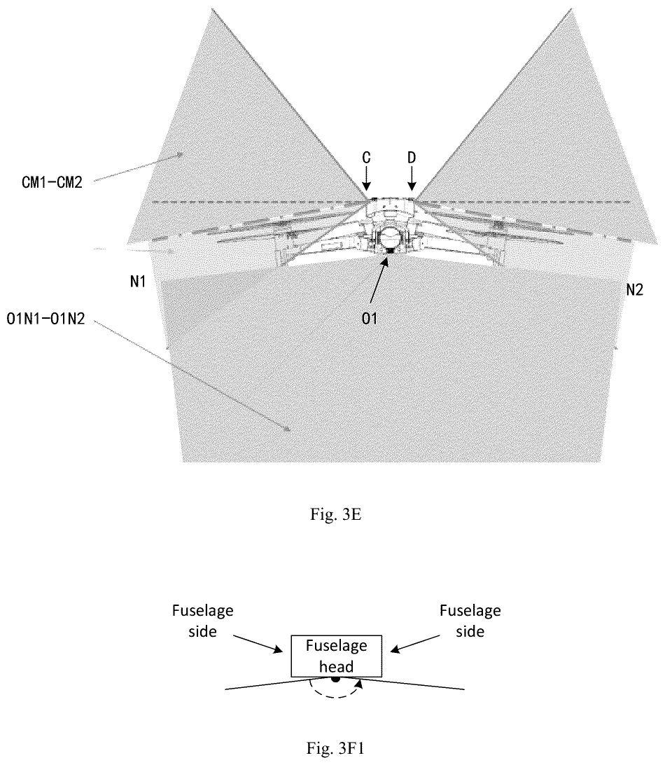

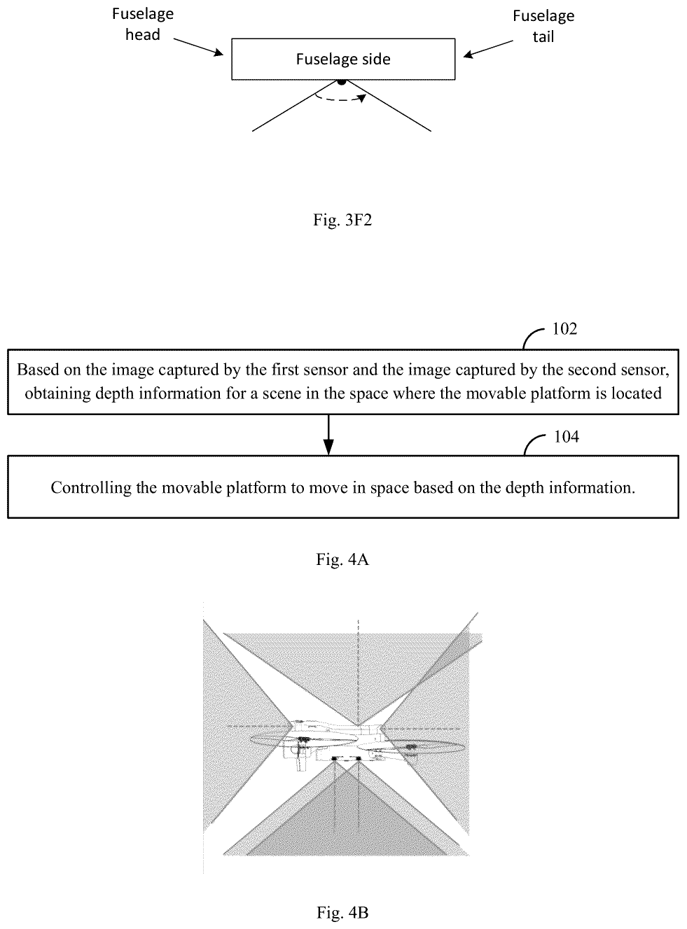

With respect to the number of sensors carried as described above, as an example, the configuration may be based on the configuration of the movable platform, such as the shape or size of the movable platform, or it may also be configured in conjunction with the application scenario of the movable platform and the observation needs. For example, the larger the movable platform is, and it is desired that the sensors cover a larger field of view, a larger number of sensors may be configured that are substantially at the same level, with each sensor having an overlapping field of view with at least two other sensors, based on which the number of sensors carried by the movable platform may be significantly reduced with respect to related techniques. Taking FIGS. 2A and 3A as an example, FIG. 3A is a schematic diagram of another UAV structure of the present embodiment, which is illustrated with four sensors, wherein any three sensors can constitute the aforementioned first sensor, second sensor, and third sensor, and by the above design, only four sensors are required to cover the entire field of view in the horizontal direction of the outside of the moveable platform, the plane in which the moveable platform body is situated, that is, it can horizontally view around the outside of the movable platform.

With respect to the mounting position of the sensors, as an example, based on the mounting position of other components on the movable platform, a certain plane on the body of the movable platform may be selected for mounting the first sensor, the second sensor, and the third sensor, and a position may be selected so that the field of view of any one of the first sensor, the second sensor, or the third sensor is not obstructed by the other components, or is obstructed by the other components as little as possible, as required, for mounting the sensors. Alternatively, this can be determined in relation to the configuration of the movable platform.

In response to the above-described sensor mounting method, in some examples, the first sensor, the second sensor, and the third sensor are respectively located on a side portion of the movable platform facing outwardly of the fuselage of the movable platform, such that environmental information on the outwardly side of the fuselage of the movable platform can be observed by the first sensor, the second sensor, and the third sensor. Using FIGS. 2A and 3A as an example, sensor C, sensor D, and sensor F are all oriented toward the outer side of the fuselage of the movable platform.

As shown in FIG. 3A, in some examples, the movable platform comprises a fuselage; the sensors are provided at corner positions of the fuselage head with the fuselage side, or the fuselage tail with the fuselage side. As an example, the fuselage in FIG. 3A is substantially rectangular in shape, and the head and tail of the fuselage are respectively equipped with sensors at corner positions with the sides, i.e., Sensor C and Sensor D are respectively equipped with sensors at corner positions between the head of the fuselage and the sides of the fuselage, Sensor E and Sensor F are respectively equipped with sensors at corner positions between the tail of the fuselage and the sides of the fuselage, and each of the sensors is oriented to the outer side of the fuselage of the movable platform. By the above-described design, it is possible to provide the movable platform with a larger field of view on the outside of the fuselage by utilizing a smaller number of sensors.

In practice, the design of the orientation of the sensor can be configured as desired, e.g., the angle of the main optical axis of the sensor, with the first axis of the sensor in the direction along the head of the fuselage to the tail of the fuselage, is not zero; and the angle of the main optical axis of the sensor, with the second axis of the sensor in the direction along the side to the side of the fuselage, is not zero. As shown in FIG. 2A, taking sensor C as an example, the main optical axis thereof is a ray between area C1 and area C2, and with sensor C as a vertex, the angle between the main optical axis and the first axis along the direction from the head of the fuselage to the tail of the fuselage is non-zero, and the angle between the main optical axis and the second axis along the direction of the side to the side of the fuselage is not zero, and by the design described above, the individual sensors can be coordinated to achieve a horizontal effect of looking around the outside of the movable platform.

In other examples, the size of the first field of view of the first sensor coinciding with the third sensor may be either the same as or different from the size of the second field of view of the second sensor coinciding with the third sensor, i.e., the orientation of the third sensor may be biased toward either of the sensors as desired.

In some examples, the field of view ranges of the at least three sensors can together form a 3600 field of view in the horizontal direction, which is the horizontal direction of the body of the movable platform, i.e. the horizontal direction of the plane in which the movable platform is located, as shown in FIGS. 2A and 3A, and the field of view ranges of the individual sensors, when combined, are able to cover the full field of view in the horizontal direction on the outer side of the movable platform, e.g. capable of looking horizontally around the outer side of the movable platform.

With respect to the design of the field of view angle of the sensor described above, a sensor with a larger field of view angle may be used as needed, as an example, the field of view angle may be greater than 90°, and the use of a field of view angle of greater than 90° allows the movable platform to achieve a larger field of view coverage with fewer sensors. In practice, other field of view angles may be designed as needed, as an example, taking four sensors as an example, for the purpose of enabling the field of view range of each sensor to be combined to horizontally look around the outside of the movable platform, the field of view angle needs to be greater than 90°, which may be determined based on the size of the field of view that the sensors and the other two sensors need to overlap. The greater the field of view that the sensor and the other sensors need to overlap, the larger the production cost of the sensor. Optionally, the field of view can be larger than or equal to 150°, or from 90° to 180° or so is optional, for example, the cost of the field of view of 180° or so is acceptable, the cost-effectiveness ratio is basically satisfied with the requirements of productization, and the difficulty of its mass production is also low, so the cost can be controlled under the circumstance of the removable platform, so that the sensor can have a large overlapping field of view with the other two sensors, and depth information with high accuracy can be acquired through the overlapping field of view.

For the type of sensor described above, as an example, a camera with a large field of view such as a fisheye camera may be used. The third sensor in this embodiment needs to have a field of view overlap with both the first sensor and the second sensor, and the fisheye camera has a larger field of view angle, so that the above design purpose can be achieved with a smaller number of sensors.

In practice, for different configurations of movable platforms, other embodiments are provided next that may enhance the accuracy of depth information perception. For example, in the foregoing embodiments, the sensors may be combined with other sensors in a binocular vision system to acquire depth information; in other examples, any of the sensors may also employ a monocular vision system to acquire depth information, based on which, when the depth information of a scene in a first direction is to be acquired, it is also acquired by a plurality of images captured by the first sensor at different positions and/or a plurality of images captured by the third sensor at different positions. That is, each sensor may use monocular vision in combination with binocular vision to acquire more depth information.

Still using FIG. 3A as an example, the movable platform comprises a fuselage, the fuselage comprising a head, a tail, and a first side and a second side between the head and the tail, the first side and the second side being disposed opposite to each other; the first sensor being disposed at a corner position between the fuselage head and the first side, the second sensor being disposed at a corner position between the fuselage tail and the second side, and the third sensor being disposed at a corner position between the fuselage head and the second side. The third sensor being provided at a corner position of the fuselage head and the second side.

The forward direction of the movable platform is the direction in which the head of the fuselage is facing. Based on power considerations, in order to reduce resistance and stabilize and control movement, the width of the head of the fuselage of the movable platform is less than the length of either of the sides, i.e., the head of the fuselage is shorter, and the two sides each are longer. Whereas sensors are provided at corner locations on the fuselage, the perceived distance of depth information in the direction of the head of the fuselage and the direction of the sides of the fuselage will be different. As can be seen from the principle of the aforementioned binocular vision system, it utilizes two cameras to form a binocular, based on the parallax principle and utilizing an imaging device to acquire two images of the object under test from different positions. The configuration of the body described above causes the spacing between the first sensor and the third sensor to be smaller than the spacing between the second sensor and the third sensor, and therefore, the observation distance of the binocular vision system formed by the first sensor and the third sensor will be smaller than the observation distance of the binocular vision system formed by the second sensor and the third sensor.

Therefore, in order to increase the observation distance and obtain more depth information within the field of view, in one embodiment, the method may further comprise: obtaining depth information of a scene in the first direction based on an image captured by the third sensor; wherein the way of obtaining depth information of a scene in the first direction based on an image captured by the third sensor is different from the way of obtaining depth information of a scene in the first direction based on images captured by the first sensor and the third sensor respectively. For example, monocular vision may be used to acquire depth information of a scene in the first direction based on images acquired by the third sensor. It will be appreciated that, in other examples, the width of the tail portion of the fuselage is also smaller than the length of either side, in which case the sensors provided at the corners of the tail portion of the fuselage and the side may be applied to the above embodiment.

As shown in FIG. 3B, a schematic diagram of the perception of depth information within the field of view around the movable platform, after the embodiment of the movable platform shown in FIG. 3A, adopts the above embodiment, in the direction of the side to the side of the fuselage, only binoculars can be used to perceive the depth information, and in the direction of the head of the fuselage to the tail of the fuselage, a combination of only binoculars and only monocular can be used to perceive more depth information.

In some examples, for a movable platform such as a drone, the movable platform comprises a fuselage, the fuselage being connected to an arm, the arm extending outwardly from the fuselage, and the arm being mounted with a power system to drive the movable platform to move in space. As shown in FIG. 3C, taking a quadrotor UAV as an example, the UAV comprises an arm 302, the arm being connected to a fuselage 301, the connection method of which may comprise a fixed connection or a movable connection, and the movable connection may comprise a foldable connection or a removable connection and the like. Wherein, when the drone moves in space, the arm 302 may be in an extended state as shown in FIG. 3C, wherein the arm 302 extends outwardly from the fuselage 301, and a power system 303 may be provided at the end of the arm 302 away from the fuselage 301, wherein the power system provided at the end of the arm away from the fuselage may include one or more of the propellers, electric motors, or ESCs in the power system. Certain components of the power system may also not be provided in the arm, for example the ESC may be provided with the fuselage according to other needs.

As shown in FIG. 3C, it is also possible to consider the location of the sensor installation in conjunction with the fuselage and the arm. As an example, one end of the arm is connected to the fuselage, and a power system is mounted on the other end of the arm, for example, a motor is mounted on the other end of the arm, and the motor is connected to a propeller.

In some examples, the sensor may be provided at an end of the arm away from the fuselage, thereby reducing the interference of the arm with the sensor's field of view, and the sensor may be able to observe a range between the fuselage to the arm, as well as the area outside of the arm, and so on.

In one embodiment, both ends of the arm may be at the same level or at different levels, e.g., the level at which one end of the arm is connected to the fuselage is below the level at which the other end of the arm is located, i.e., the arm extends outwardly and upwardly with respect to the fuselage; or, as illustrated in FIG. 3C, the level at which one end of the arm is connected to the fuselage is above the level at which the other end of the arm is located, i.e., the arm extends outwardly and downwardly relative to the fuselage.

In order to reduce the obstruction of the field of view of the sensor by the arm, in this embodiment, at least a part of the arm is located below the plane in which the first sensor, second sensor and third sensor are located, so that the obstruction of the field of view of the sensor by the arm can be reduced; wherein it can be that a part of the arm is located below the plane in which the first sensor, second sensor and third sensor are located; or it can be that, as shown in FIG. 3C. wherein sensor 304 is illustrated in FIG. 3C, with all of the arm located below the plane in which the first sensor, second sensor, and third sensor are located.

As described in FIG. 3D, a schematic view of a field of view range of a sensor of a UAV illustrated in one embodiment, which is a main view of the UAV, i.e., a view of the UAV obtained by making a forward projection from the nose of the UAV to the tail of the UAV. FIG. 3D shows, for example, sensor C and sensor D. The boundaries of the field of view range of sensor C are CM1 and CM3, with a field of view range of CM1-CM3, the upper surface of the power system mounted on the arm, i.e., the upper surface of the propeller, is CM2, and the arm is located under the plane where sensor C and sensor D are located, i.e., the arm is located in the plane to which CD is attached; only a small portion of the field of view range of sensor C covered by the arm is obscured, and the sensor has a large reliable observation range.

As can be seen from the above embodiments, the movable platform is set up where the first sensor, the second sensor and the third sensor are located, so as to be able to realize a large field of view coverage with a small number of sensors, and also to be able to obtain reliable and rich depth information by means of binocular vision. In practice, some movable platforms also have certain observation requirements for the underside of the movable platform, based on which, in some embodiments, the movable platform may comprise a fourth sensor, the fourth sensor facing towards the underside of the movable platform; based on which, the movable platform can be observed by the design of the fourth sensor, and therefore, the method further comprises: based on an image acquired by the fourth sensor, obtaining depth information of a scene below the movable platform.

In one embodiment, the setting position of the fourth sensor may be designed based on the configuration of the movable platform and the setting of other components on the movable platform, and it is only necessary that the fourth sensor is oriented towards the underside of the movable platform to be able to supplement the field of view of the underside of the movable platform.

In one embodiment, the fourth sensor is directed toward the underside of the movable platform, there may also be various ways of realizing the same as needed, for example, it may be that the main optical axis of the fourth sensor is vertically downward, or it may be that it is not vertically downward in design, and the fourth sensor has a certain field of view as long as part of the field of view range is directed toward the underside of the movable platform. In addition, the number of the fourth sensor can be flexibly selected according to the configuration and size of the movable platform, and this embodiment does not limit this. As an example, the movable platform comprises at least two of the fourth sensors, and due to the limitation of the field of view of the sensors, the at least two sensors may be arranged and disposed in a direction from the head of the fuselage to the tail, so that a field of view underneath the movable platform, in a direction from the head of the fuselage to the tail, may be provided.

In practical application, since the fourth sensor is facing the underside of the movable platform, in some scenarios, the movable platform may block the light underneath the movable platform, resulting in weak ambient brightness underneath the movable platform, based on which, in some examples, the movable platform may also include a lighting assembly, with the lighting assembly facing the underside of the movable platform, so that the lighting assembly may provide better ambient brightness for the fourth sensor, so that the movable platform may collect images containing rich image information, thereby ensuring safe and reliable depth information based on images captured by the fourth sensor, and thereby ensuring safe movement of the movable platform.

Therein, the location and number of the lighting assemblies can be set up in a variety of configurations as needed, for example, they can be set up in the direction of the head of the body of the movable platform, or they can be set up close to the fourth sensors, or, in the case of at least two fourth sensors, the lighting assembly may be set up between at least two fourth sensors, so that the fourth sensors can, through a smaller number of the lighting assembly, be provided with better ambient brightness so that the fourth sensors can better capture images underside of the movable platform.

In practice, a number of different realizations of the fourth sensors can be configured according to the configuration of the movable platform and the position of other components on the movable platform, such as the setting of the field of view of the fourth sensor. Still taking FIG. 3D as an example, wherein the arm is located under the plane where the first sensor, second sensor and third sensor are located, but a small portion of the field of view range of the sensors is blocked by the arm, and the UAV is also provided with a fourth sensor, i.e., the sensor O1 in FIG. 3D, The boundaries of the field of view range of the sensor O1 are N1 and N2, which is considered to solve the field of view coverage only below the movable platform, and the movable platform actually still has some unreliable observation areas and blind zones, for example, the unreliable observation areas CM2-CM3, which are the field of view in the sensor C that is blocked by the arm, and there is a blind zone on the lower surface of the arm P. The customary thinking is that the fourth sensor, as a downward vision sensor of the movable platform, only considers the direction below the movable platform.

Unlike the usual role of sensors for downward vision, the setting of the fourth sensor in one embodiment also takes into account the positional relationship and blind zones of the arm, the first sensor, the second sensor and the third sensor; in this embodiment, the upper boundary of the field of view of the fourth sensor in the direction of the height of the movable platform coincides or intersects with the lower surface of the arm. The present embodiment may be understood to mean that the field of view of the fourth sensor is as close as possible to the arm to complement the field of view under the arm. Wherein the height direction of the movable platform of the present embodiment refers to the height direction of the movable platform resulting from the movement of the movable platform in space at a different height from the ground; whereas the movement back and forth under the same height is a horizontal direction.

In one embodiment, a lower boundary of a field of view of any of the at least three sensors along a height direction of the movable platform intersects with a portion of the power system, and/or wherein a lower boundary of a field of view of any of the at least three sensors along a height direction of the movable platform intersects with a portion of the arm.

Alternatively, the upper boundary of the field of view of the fourth sensor along the height direction of the movable platform intersects with a portion of the power system, and/or the upper boundary of the field of view of the fourth sensor along the height direction of the movable platform intersects with a portion of the arm.

In the present embodiment, both overlap and intersection are optional implementations, wherein in the overlap approach, the arms are not present in the field of view of the fourth sensor, and in the intersection approach, part of the arms may be present in the field of view of the fourth sensor. As shown in FIG. 3E, a schematic view of the field of view range of another sensor of the movable platform in this embodiment, which is a main view of the UAV, with respect to FIG. 3D, the upper boundary of the field of view angle of the fourth sensor (which is provided at position O1 in the figure) in the direction of the height of the movable platform (line O1N1 or line O1N2 in the figure) coincides with the lower surface of the arm, such that the fourth sensor is able to provide the movable platform with a field of view range under the lower surface of the arm (i.e., the region O1N1-O1N2 in FIG. 3E)

In other examples, with the fourth sensor as a vertex, the field of view of the fourth sensor in a direction along the head of the fuselage to the tail of the fuselage is less than or equal to the field of view in a direction along one side to another side of the fuselage. As illustrated in conjunction with other accompanying drawings, as shown in FIGS. 3F1 to 3F2, a schematic view of a field of view range of another fourth sensor in this embodiment, in this embodiment, FIG. 3F1 is a main view which illustrates a first field of view angle of the fourth sensor in the direction of side-to-side of the fuselage along the height direction of the movable platform, which first field of view angle is also known as the field of view angle of the fourth sensor in the direction of both sides of the fuselage, with the fourth sensor as the apex. FIG. 3F2 is a side view illustrating a second field of view angle of the fourth sensor along the fuselage in a head-to-tail direction along the height direction of the removable platform, the second field of view angle being also the field of view angle of the fourth sensor along the fuselage in a head-to-tail direction with the fourth sensor as a vertex, wherein the first field of view angle is greater than the second field of view angle.

Based on this, the sensor usually has a field of view in two directions, and if the size of the two fields of view is different, the movable platform is desired to be covered more along the fuselage side-to-side direction to supplement the fuselage side blind zones, and by the design described above, it is possible for the fourth sensor to observe the underside of the movable platform, and also to provide a field of view around the arm or under the arm, which reduces the blind zones of the movable platform.

In other examples, the movable platform comprises a binocular sensor, the binocular sensor being oriented above the movable platform when the movable platform is moved; the method further comprising: acquiring depth information of a scene above the movable platform based on an image captured by the binocular sensor. By the setting of the binocular sensor, it provides the movable platform with a field of view range above it, so that the depth information of the scenery above the movable platform can be acquired. Among them, the setting position and number of the binocular sensors may be determined according to actual needs, for example, it may be a pair of binocular cameras or a plurality of pairs of binocular cameras; the setting position may comprise the top of the body of the movable platform, or it may be embedded in the body of the movable platform and oriented towards the upper part of the movable platform, and the orientation may be that the main optical axis is vertically upward, or it may be not vertically upward and so on, and this embodiment does not limit this.

In response to the blind spot on the side of the moveable platform, the present specification also provides another method of controlling the moveable platform, shown in FIG. 3C, wherein the moveable platform comprises a body 301 and an arm 302, wherein the arm 302 extends outwardly from the body 301, wherein the arm 302 is used for mounting a power system 303 of the moveable platform;
The body carries a first sensor 304 and a second sensor (not shown in FIG. 3C);
The first sensor 304 faces toward the side of the movable platform and the second sensor faces toward the underside of the movable platform;
A portion of the arm is disposed between a lower boundary of a field of view of the first sensor along a height direction of the movable platform and an upper boundary of a field of view of the second sensor along a height direction of the movable platform.

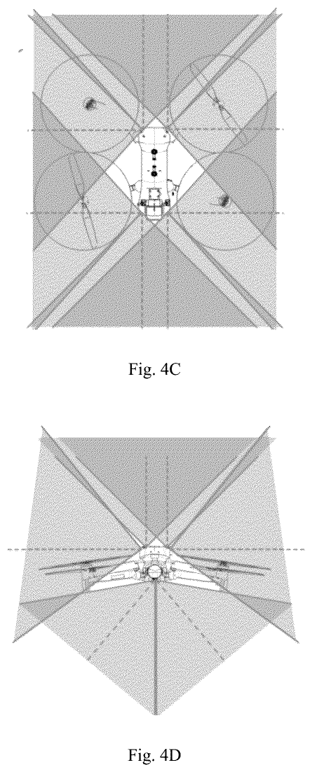

As shown in FIG. 4A, a flowchart of a method of controlling a movable platform illustrated in the present application according to an exemplary embodiment, comprising the following steps:
In step 402, based on the image captured by the first sensor and the image captured by the second sensor, depth information is obtained for a scene in the space where the movable platform is located;
In step 404, the movable platform is controlled to move in space based on the depth information.

In some examples, a lower boundary of a field of view of the first sensor along the height direction of the movable platform intersects with a portion of the power system, and/or, intersects with a portion of the arm; and an upper boundary of a field of view of the second sensor along the height direction of the movable platform intersects with a portion of the power system, and/or, intersects with a portion of the arm.

In some examples, the second sensor may face toward the underside of the movable platform, either with the main optical axis of the fourth sensor vertically downwards or in a design that is not vertically downwards, as desired, with the second sensor having a certain field of view, as long as a part of the field of view is oriented towards the underside of the movable platform.

In this embodiment, the upper boundary of the field of view of the second sensor along the height direction of the movable platform coincides or intersects with the lower surface of the arm. It is understood in this embodiment that the field of view of the fourth sensor is as close as possible to the arm to complement the field of view under the arm.

In some examples, the removable platform comprises a fuselage;
The first sensor is provided at a corner position between the head of the fuselage and a side of the fuselage or between the tail of the fuselage and a side of the fuselage.

In some examples, the movable platform comprises a fuselage;
(a) the main optical axis of the first sensor has an angle of non-zero with respect to the first axis of the first sensor in a direction along the head of the fuselage to the tail of the fuselage; or.
the main optical axis of the first sensor has a non-zero angle with respect to the direction of the first sensor in a direction along a side-to-side of the fuselage.

In some examples, the movable platform comprises a fuselage, the fuselage being connected to an arm, the first sensor being provided at an end of the arm away from the fuselage.

Next, an embodiment is used to illustrate the present application program. The main shortcoming of some UAVs in perceiving obstacle avoidance is that the range of obstacle avoidance taking effect is small, and there are more dead zones in the perception blind zone. This leads to the possibility of falling due to failure of obstacle avoidance, and the possibility of cutting out intelligent flight due to insufficiently intelligent obstacle avoidance. Continuously, limited by cost, realization difficulty and other engineering problems, omnidirectional perception obstacle avoidance mainly exists in the academic community. The realization of omnidirectional perception, there are three main approaches, namely: the use of omnidirectional cameras, but such cameras usually only have a low spatial resolution, and can not complete the accurate perception; the use of as wide as possible angle of the visual sensors as much as possible to complete the perception of space, for example, through 12 perception cameras to achieve the omnidirectional perception; the use of more visual sensors as much as possible to complete the perception of space, so that the visual sensors rotate up, with a single vision sensor covering a larger spatial range. However, no matter which approach, under the limitations of the size and appearance of consumer-grade UAVs, the placement of sensors has greater limitations, so it is necessary to re-construct the design of the configuration, adjust the folding method, and estimate the structural shape, etc. At the same time, no matter what the structural design is, it is subject to the limitations of the size and appearance. At the same time, no matter how the structure is designed, limited by the FOV, there is always a certain blind spot in the above methods, and the propeller's obstruction can't be avoided, so how to realize a better depth map perception under the obstruction of the propeller is also an approach that needs to be paid attention to. In the case of existing quadcopter UAVs, placing the binoculars toward the high ground is a feasible solution, but it will bring additional structural requirements.

One embodiment of the present application proposes a UAV perception scheme with dead-angle-free, omnidirectional perception for a consumer-grade UAV with size constraints; the scheme has complete dead-angle-free omnidirectional perception coverage, and can complete stable and reliable binocular observation in all directions using only eight vision sensors, while there is no dead-angle, and solves the obstruction problem of the fuselage, arm, and blade structures for the vision system. The embodiment of sensing depth information used in this application eliminates the need for calculating large FOV fisheye depth maps and the huge amount of computation for modeling directly using fisheye depth maps, eliminates the need for high performance computing chips, and reduces the requirements for power consumption and heat dissipation.

As shown in FIGS. 4B, 4C, and 4D, a side view, a top view, and a front view of a UAV of one embodiment of the present application, which illustrate the field of view range of the visual sensors of the present embodiment; the visual sensors of the present embodiment are arranged on the UAV in the following manner:
Two camera modules are used:
Fisheye cameras, such as those with a horizontal FOV of 185 degrees and a vertical FOV of 140 degrees, etc;
Wide angle cameras, e.g. 105 degrees horizontal FOV, 90 degrees vertical FOV, etc;
Four fisheye cameras are arranged at four corners of the left front, right front, left rear and right rear of the UAV, and the angles between the optical axes of the fisheye cameras and the nose axis of the UAV are −45 degrees, 45 degrees, 135 degrees, and 225 degrees; a pair of fisheye cameras is deployed underneath the UAV along the front and rear directions, with the optical axes vertically downward; and a pair of wide-angle cameras is arranged on the top of the UAV, with the optical axes vertically upward.

Different directions are perceived in different ways as:
Upper directional perception: single-directional stereo perception is realized by a pair of normal wide-angle binoculars;
Horizontal perception: 360-degree stereo perception in the horizontal direction is realized by four fisheye cameras;
Downward orientation perception: a pair of fisheye cameras realizes unidirectional stereo perception close to the hemisphere level;
In the horizontal direction, there is one fisheye camera with a larger FOV for each of the left front, right front, left rear, and right rear of the airplane, and the four cameras cover the entire field of view constituting horizontal omnidirectional perception. There is no occlusion in the forward and backward directions, and no occlusion in the left and right directions, but there is a larger perception distance in the side direction than that in the forward and backward directions.

This embodiment uses four fisheye cameras to cover the omnidirectional, fisheye camera cost is higher, but the cost of the 180-degree FOV fisheye camera is acceptable, the cost-effectiveness ratio basically meets the requirements of the productization. 180-degree FOV fisheye camera mass production is less difficult, compared to the lens of a larger FOV, the cost of controlling more easily.

Although there is some occlusion in the left and right directions, obstacles can be detected and maps built at three times the distance due to the greater length of the fuselage side, which is approximately three times the forward vision of the fuselage head.

In the forward and backward directions, in order to achieve an observation distance that matches the left and right directions, the missing front and back observation distances are made up by a monocular vision system.

The UAV of one embodiment of this application has no blind zones in the left and right directions; at the same time, since the reliable observation range of the downward-looking fisheye camera intersects with the reliable observation range of the circular-looking fisheye camera, the unreliable observation distance caused by the obstruction of the arm and paddle structure is very small, and is only concentrated near the fuselage. Based on this, a dead-angle free omnidirectional sensing system is realized.

The specific realization process of the above embodiments can be referred to the description of the previous embodiments, and the present embodiments will again not be repeated.

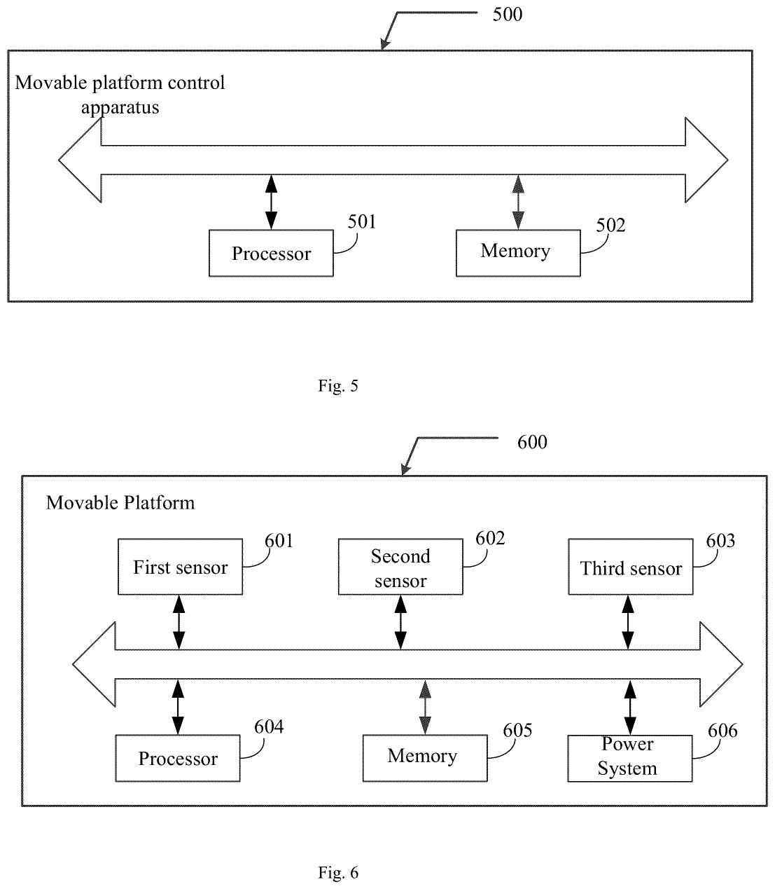

The method embodiments described above may be realized by software, by hardware or by a combination of hardware and software. In the case of the software implementation, for example, as a device in a logical sense, it is formed by reading the corresponding computer program instructions in the non-volatile memory into the memory to run through the processor for image processing in which it is located. In terms of the hardware level, as shown in FIG. 5, a hardware structure diagram of one type of the control device 500 for implementing the movable platform of the present embodiment is shown, and in addition to the processor 501, and the memory 502 shown in FIG. 5, the image processing apparatus used in the embodiment for implementing the present method of image processing may, usually according to the actual function of the image processing apparatus, include other hardware, which will not be further described herein.

In this embodiment, the processor 501 implements the following steps when executing the computer program:
obtaining depth information of a scene in the first direction based on images captured by the first sensor and the third sensor, respectively;
obtaining depth information of the scene in the second direction based on the images captured by the second sensor and the third sensor, respectively;
controlling the movement of the movable platform in space based on the depth information.

The movable platform comprises a body and an arm, the body being connected to the arm; the at least three sensors being mounted on the body;
The arm is used to mount the power system of the movable platform, wherein at least a portion of the arm is located below the plane in which the first sensor, second sensor and third sensor are located.

In some examples, the first sensor, the second sensor, and the third sensor are all located on a side of the removable platform respectively, towards the outside of the body of the removable platform.

In some examples, the movable platform comprises a fourth sensor, the fourth sensor facing downwardly of the movable platform;
The processor also performs:
obtaining depth information of a scene below the movable platform based on an image captured by the fourth sensor.

In some examples, with the fourth sensor as a vertex, the field of view of the fourth sensor in a direction along the head of the fuselage to the tail of the fuselage is less than or equal to the field of view in a direction along the side-to-side of the fuselage.

In some examples, the upper boundary of the field of view angle of the fourth sensor along the height direction of the movable platform coincides or intersects with the lower surface of the arm.

In some examples, the removable platform comprises at least two fourth sensors, the at least two fourth sensors being disposed in an arrangement in a direction from the head to the tail of the fuselage.

In some examples, the removable platform further comprises a lighting assembly, the lighting assembly facing downward of the removable platform.

In some examples, the lighting assembly is provided between at least two of the fourth sensors.

In some examples, the depth information of the scene in the first direction is also obtained from a plurality of images captured by the first sensor at different locations and/or a plurality of images captured by the third sensor at different locations.

In some examples, the movable platform comprises a fuselage, the fuselage comprising a head, a tail, and a first side and a second side between the head and the tail, the first side and the second side being disposed opposite each other;
The first sensor is provided at a corner position of the fuselage head and the first side, the second sensor is provided at a corner position of the fuselage tail and the second side, and the third sensor is provided at a corner position of the fuselage head and the second side;
The width of the fuselage head is less than the length of either side;
The method further comprises:
obtaining depth information of a scene in the first direction based on an image captured by the third sensor;
wherein the manner of obtaining depth information of a scene in the first direction based on an image captured by the third sensor is different from the manner of obtaining depth information of a scene in the first direction based on images captured by the first sensor and the third sensor respectively.

In some examples, the field of view of the at least three sensors, together constitute a 360° field of view in the horizontal direction.

In some examples, the movable platform comprises a fuselage;
The sensor is provided at a corner position of the fuselage head and the fuselage side, or of the fuselage tail and the fuselage side.

In some examples, the movable platform comprises a fuselage;
(a) the main optical axis of the sensor has an angle of non-zero with respect to the first axis of the sensor in a direction along the head of the fuselage to the tail of the fuselage; or.

The main optical axis of the sensor has a non-zero angle with respect to the second axis of the sensor in a direction along side-to-side of the fuselage.

In some examples, the movable platform comprises a body, the body being connected to an arm, the arm extending outwardly from the body, the sensor being provided at an end of the arm away from the body.

In some examples, the sensor has a horizontal field of view greater than 90°.

In some examples, the sensor comprises: a fisheye camera.

In some examples, the movable platform comprises a binocular sensor, the binocular sensor facing upwards of the movable platform when the movable platform is moved;
The processor also performs:
obtaining depth information of a scene above the movable platform based on an image captured by the binocular sensor.

As shown in FIG. 6, this embodiment also provides a movable platform, the movable platform 600 comprising: at least three sensors;
Of the at least three sensors, the first sensor 601, the second sensor 602 and the third sensor 603 are substantially at the same level;
The first sensor has an overlapping first field of view with the third sensor, the first field of view being used to observe the view in the first direction of the movable platform;
The second sensor has an overlapping second field of view with the third sensor, the second field of view being used to observe the scene in the second direction of the movable platform; the first direction being different from the second direction;
The movable platform further includes a processor 604, a memory 605, a computer program stored on the memory executable by the processor;
The movable platform further comprises a power system 606;
The processor implements the following steps when executing the computer program:
obtaining depth information of a scene in the first direction based on images captured by the first sensor and the third sensor, respectively;
obtaining depth information of the scene in the second direction based on the images captured by the second sensor and the third sensor, respectively;
controlling the movement of the movable platform in space based on the depth information.

The movable platform comprises a body and an arm, the body being connected to the arm; the at least three sensors being mounted on the body;
The arm is used to mount the power system of the movable platform, wherein at least a portion of the arm is located below the plane in which the first sensor, second sensor and third sensor are located.

In some examples, the first sensor, the second sensor, and the third sensor are all located on a side of the movable platform, towards the outside of the body of the movable platform.

In some examples, the movable platform comprises a fourth sensor, the fourth sensor facing downwardly of the movable platform;
The processor also performs:
obtaining depth information of a scene below the movable platform based on an image captured by the fourth sensor.

In some examples, with the fourth sensor as a vertex, the field of view of the fourth sensor in a direction along the head of the fuselage to the tail of the fuselage is less than or equal to the field of view in a direction along the side-to-side of the fuselage.

In some examples, the upper boundary of the field of view angle of the fourth sensor along the height direction of the movable platform coincides or intersects with the lower surface of the arm.

In some examples, the movable platform comprises at least two fourth sensors, the at least two fourth sensors being disposed in an arrangement in a direction from the head to the tail of the fuselage.

In some examples, the movable platform further comprises a lighting assembly, the lighting assembly facing downward of the movable platform.

In some examples, the lighting assembly is provided between at least two of the fourth sensors.

In some examples, the depth information of the scene in the first direction is also obtained from a plurality of images captured by the first sensor at different locations and/or a plurality of images captured by the third sensor at different locations.

In some examples, the movable platform comprises a body, the body comprising a head, a tail, and a first side portion and a second side portion between the head and the tail, the first side portion and the second side portion being disposed opposite each other;
The first sensor is provided at a corner position of the fuselage head and the first side portion, the second sensor is provided at a corner position of the fuselage tail and the second side portion, and the third sensor is provided at a corner position of the fuselage head and the second side portion;
The width of the fuselage head is less than the length of either side portion;
The method further comprises:
obtaining depth information of a scene in the first direction based on an image captured by the third sensor;
wherein the manner of obtaining depth information of a scene in the first direction based on an image captured by the third sensor is different from the manner of obtaining depth information of a scene in the first direction based on images captured by the first sensor and the third sensor respectively.

In some examples, the field of view of the at least three sensors, together constitute a 3600 field of view in the horizontal direction.

In some examples, the movable platform comprises a fuselage;
The sensor is provided at a corner position of the fuselage head and the fuselage side, or of the fuselage tail and the fuselage side.

In some examples, the movable platform comprises a fuselage;
(a) the main optical axis of the sensor has an angle of non-zero with respect to the first axis of the sensor in a direction along the head of the fuselage to the tail of the fuselage; or.

The main optical axis of the sensor has a non-zero angle with respect to the second axis of the sensor in a direction along side-to-side of the fuselage.

In some examples, the movable platform comprises a body, the body being connected to an arm, the arm extending outwardly from the body, the sensor being provided at an end of the arm away from the body.

In some examples, the sensor has a horizontal field of view greater than 90°.

In some examples, the sensor comprises: a fisheye camera.

In some examples, the movable platform comprises a binocular sensor, the binocular sensor facing upwards of the movable platform when the movable platform is moved;
The processor also performs:
obtaining depth information of a scene above the movable platform based on an image captured by the binocular sensor.

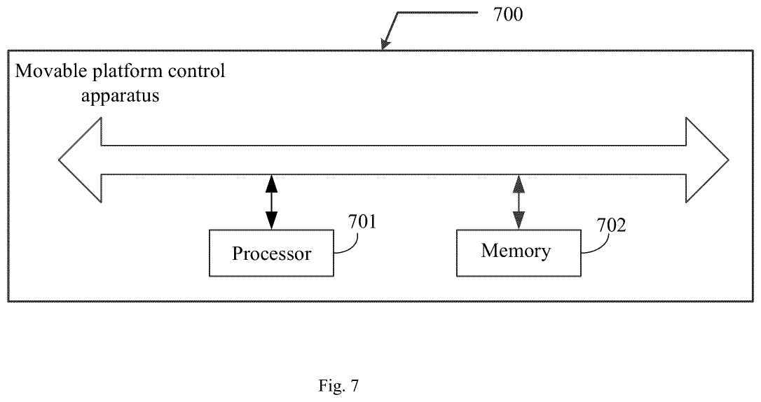

As shown in FIG. 7, one embodiment also provides another control apparatus for a movable platform, the movable platform comprising a body and an arm, the arm extending outwardly from the body, the arm being used to mount a power system of the movable platform;
The body carries a first sensor and a second sensor;
The first sensor is oriented to the side of the movable platform and the second sensor is oriented to the underside of the movable platform;
A portion of the arm is disposed between a lower boundary of a field of view of the first sensor along a height direction of the movable platform and an upper boundary of a field of view of the second sensor along a height direction of the movable platform;
The apparatus comprises a processor, a memory, a computer program stored in the memory executable by the processor, the processor executing the computer program realizing the following steps:
obtaining depth information of a scene in the space in which the movable platform is located based on an image captured by the first sensor and an image captured by the second sensor;
controlling the movement of the movable platform in space based on the depth information.

In some examples, the movable platform comprises a fuselage;
The first sensor is provided at a corner position between the head of the fuselage and a side of the fuselage, or between the tail of the fuselage and a side of the fuselage.

In some examples, the movable platform comprises a fuselage;
(a) the main optical axis of the first sensor has an angle of non-zero with respect to the first axis of the first sensor in a direction along the head of the fuselage to the tail of the fuselage; or.

The main optical axis of the first sensor has a non-zero angle with respect to the direction of the first sensor along side-to-side of the fuselage.

In some examples, the movable platform comprises a body, the body being connected to an arm, the first sensor being provided at an end of the arm away from the body.

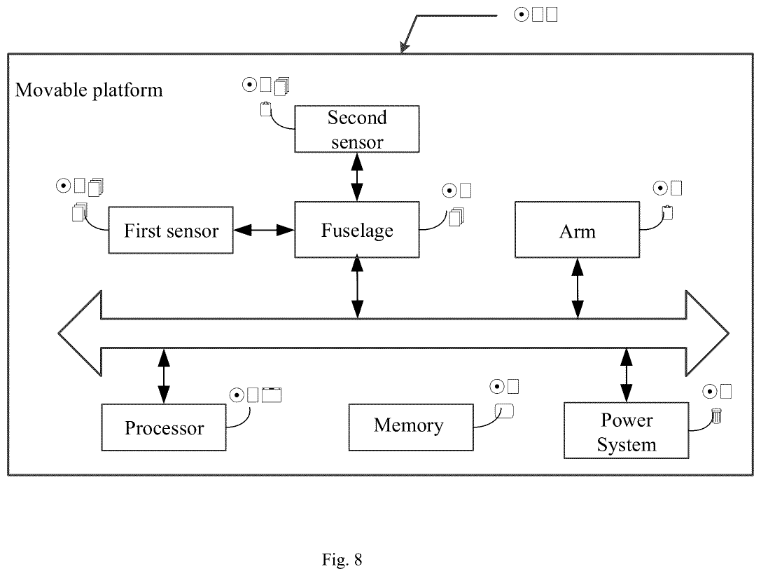

As shown in FIG. 8, one embodiment of the present application also provides a movable platform, the movable platform 800 comprising a body 801 and an arm 802, the arm extending outwardly from the body, the arm being used to mount a power system 803 of the movable platform;
The body carries a first sensor 8011 and a second sensor 8012;
The first sensor 8011 faces toward the side of the movable platform and the second sensor 8012 faces toward the underside of the movable platform;
A portion of the arm is disposed between a lower boundary of a field of view of the first sensor along a height direction of the movable platform and an upper boundary of a field of view of the second sensor along a height direction of the movable platform;
The removable platform further comprises a processor 804, a memory 805, a computer program stored in the memory executable by the processor, the processor executing the computer program implementing the following steps:
obtaining depth information of a scene in the space in which the movable platform is located based on an image captured by the first sensor and an image captured by the second sensor;
controlling the movement of the movable platform in space based on the depth information.

In some examples, the movable platform comprises a fuselage;
The first sensor is provided at a corner position between the head of the fuselage and a side of the fuselage, or between the tail of the fuselage and a side of the fuselage.

In some examples, the movable platform comprises a fuselage;
(a) the main optical axis of the first sensor has an angle of non-zero with respect to the first axis of the first sensor in a direction along the head of the fuselage to the tail of the fuselage; or.

The main optical axis of the first sensor has a non-zero angle with respect to the direction of the first sensor along side to side of the fuselage.

In some examples, the movable platform comprises a body, the body being connected to an arm, the first sensor being provided at an end of the arm away from the body.

Embodiments of the present specification further provide a computer readable storage medium, the readable storage medium having stored thereon a number of computer instructions, the computer instructions being executed to actualize the steps of the method of controlling a removable platform as described in any of the above embodiments.

Embodiments of the present specification may take the form of a computer program product implemented on one or more storage media (including, but not limited to, disk memory, CD-ROM, optical memory, and the like) containing program code therein. Computer usable storage media include permanent and non-permanent, removable and non-removable media, and may be implemented by any method or technique for information storage. The information may be computer-readable instructions, data structures, modules of a program, or other data. Examples of storage media for computers include, but are not limited to, phase-change memory (PRAM), static random access memory (SRAM), dynamic random access memory (DRAM), other types of random access memory (RAM), read-only memory (ROM), electrically erasable programmable read-only memory (EEPROM), flash memory or other memory technologies, read-only CD-ROM only Read-Only Memory (CD-ROM), Digital Versatile Disc (DVD) or other optical storage, magnetic cartridge tapes, magnetic tape disk storage or other magnetic storage devices, or any other non-transport media that can be used to store information that can be accessed by computing devices.

For the device embodiment, since it corresponds essentially to the method embodiment, it is sufficient to refer to a portion of the description of the method embodiment where relevant. The above-described device embodiments are merely schematic, wherein the units described as illustrated as separated components may or may not be physically separated, and the components shown as units may or may not be physical units, i.e., they may be located in one place or may be distributed to a plurality of network units. Some or all of these modules may be selected to fulfill the purpose of the embodiment scheme according to actual needs. It can be understood and implemented by a person of ordinary skill in the art without creative labor.

It should be noted that, in this document, relational terms such as first and second are used only to distinguish one entity or operation from another, and do not necessarily require or imply the existence of any such actual relationship or order between those entities or operations. The terms “including”, “comprising”, or any other variant thereof, are intended to cover non-exclusive inclusion, so that a process, method, article or apparatus comprising a set of elements includes not only those elements, but also other elements that are not expressly enumerated, or that a process, method, article or apparatus comprising a set of elements for such a process, method, article or apparatus is also included. Or it also includes elements that are inherent to such process, method, article or apparatus. Without further limitation, the fact that an element is defined by the phrase “includes a . . . ” does not preclude the existence of another identical element in the process, method, article or apparatus that includes the element.

The method and apparatus provided by the embodiments of the present disclosure are described in detail above, and specific examples are applied herein to elaborate on the principles and implementation of the present disclosure, and the description of the above embodiments is only used to help understand the method of the present disclosure and its core ideas; at the same time, for the general technical personnel in the field, based on the ideas of the present disclosure, there will be changes in the specific implementations and the scope of the application. In summary, the contents of this specification should not be construed as a limitation of the present disclosure.

What is claimed is:

1. A control apparatus for a movable platform, comprising:
at least one processor; and
at least one memory including computer program code, where the at least one memory and the computer program code are configured, with the at least one processor, to cause the apparatus to at least:
obtain depth information of a scene in a first direction based on a first image captured by a first sensor of the movable platform and a third image by a third sensor of the movable platform, respectively;
obtain depth information of a scene in a second direction based on a second image captured by a second sensor of the movable platform and the third image by the third sensor of the movable platform, respectively; and
control movement of the movable platform in space based on the depth information of the scene in both the first direction and the second direction;
wherein the first sensor, the second sensor and the third sensor are mounted on the movable platform at substantially a same level;
the first sensor has a first overlapping field of view with the third sensor to form a first binocular system to observe the scene in the first direction of the movable platform; and
the second sensor has a second overlapping field of view with the third sensor to form a second binocular system to observe the scene in the second direction of the movable platform; the first direction being different from the second direction.

2. The control apparatus according to claim 1, wherein the movable platform further comprises a body and an arm, the body being connected to the arm; the first sensor, the second sensor, and the third sensor being mounted on the body; and
the arm is configured to mount a power system of the movable platform, wherein at least a portion of the arm is located below a plane in which the first sensor, second sensor and third sensor are located.

3. The control apparatus according to claim 2, wherein the first sensor, the second sensor, and the third sensor are respectively located on a side of the removable platform facing outside of the body of the removable platform.

4. The control apparatus according to claim 2, wherein the movable platform further comprises a fourth sensor facing downwardly from the movable platform, and
the at least one memory and the computer program code are further configured, with the at least one processor, to cause the apparatus to at least obtain depth information of a scene below the movable platform based on an image captured by the fourth sensor of the movable platform.

5. The control apparatus according to claim 4, wherein, with the fourth sensor as a vertex, a field of view of the fourth sensor in a direction along a head of the body to a tail of the body is less than or equal to a field of view of the fourth sensor in a direction along a side of the body.

6. The control apparatus according to claim 4, wherein an upper boundary of the field of view of the fourth sensor along a height direction of the movable platform coincides or intersects with a lower surface of the arm.

7. The control apparatus according to claim 4, wherein the movable platform comprises at least two fourth sensors, the at least two fourth sensors being disposed in a direction from a head to a tail of the body.

8. The control apparatus according to claim 7, wherein the movable platform further comprises a lighting assembly, the lighting assembly facing downwardly from the movable platform or the lighting assembly being disposed between two of the at least two fourth sensors.

9. The control apparatus according to claim 1, wherein the movable platform comprises a body, the body including a head, a tail, a first side and a second side between the head and the tail, the first side and the second side being disposed opposite each other;
the first sensor is disposed at a corner position of the head and the first side, the second sensor is disposed at a corner position of the tail and the second side, and the third sensor is provided at a corner position of the head and the second side;
a width of the head is less than a length of each of the first side or the second side; and
the at least one memory and the computer program code are further configured, with the at least one processor, to cause the apparatus to at least:
obtain the depth information of the scene in the first direction based on images captured by the third sensor as a monocular system; wherein
a first manner of obtaining the depth information of the scene in the first direction is different from a second manner of the scene in the first direction based on the images, the first manner of obtaining the depth information of the scene in the first direction being based on the image captured by the third sensor, the second manner of obtaining the depth information of the scene in the first direction being based on the images captured by the first sensor and the third sensor respectively.

10. The control apparatus according to claim 1, wherein field of views of the at least three sensors together form a field of view being 360° in a horizontal direction.

11. The control apparatus according to claim 1, wherein the movable platform comprises a body, the body including a head, a tail, a first side and a second side between the head and the tail, the first side and the second side being disposed opposite each other; and
the first sensor, the second sensor, and the third sensor are each disposed at a corner position of the head and one of the first side or the second side, or of the tail and one of the first side or the second side.

12. The control apparatus according to claim 1, wherein the movable platform comprises a body;
a main optical axis of the third sensor has a non-zero angle with respect to a first axis in a direction along a head of the body to a tail of the body; or
the main optical axis of the third sensor has a non-zero angle with respect to a second axis in a direction along a side-to-side of the body.

13. The control apparatus according to claim 1, wherein the movable platform comprises a body, the body being connected to an arm, the arm extending outwardly from the body, each of the first sensor, the second sensor, and the third sensor being provided at an end of the arm away from the body, respectively.

14. A control apparatus for a movable platform, comprising:
at least one processor; and
at least one memory including computer program code, where the at least one memory and the computer program code are configured, with the at least one processor, to cause the apparatus to at least:
obtain depth information of a scene based on an image captured by a first sensor of the movable platform and a second image by a second sensor of the movable platform, respectively; and
control movement of the movable platform in space based on the depth information of the scene,
wherein the movable platform comprises a body and an arm, the arm extending outwardly from the body, the arm being configured to mount a power system for the movable platform;
the first sensor is oriented toward outside of the movable platform and the second sensor is oriented toward an underside of the movable platform; and
a portion of the arm is disposed between a lower boundary of a field of view of the first sensor along a height direction of the movable platform and an upper boundary of a field of view of the second sensor along the height direction of the movable platform.

15. The control apparatus according to claim 14, wherein the first sensor is disposed at a corner position between a head of the body and a side of the body, or between a tail of the body and the side of the body.

16. The control apparatus according to claim 14, wherein
a main optical axis of the first sensor has a non-zero angle with respect to a first axis of the first sensor in a direction along a head of the body to a tail of the body; or
the main optical axis of the first sensor has a non-zero angle with respect to a direction of the first sensor along a side-to-side of the body.

17. The control apparatus according to claim 14, wherein
the movable platform comprises a body, the body being connected to an arm, the arm extending outwardly from the body, each of the first sensor, the second sensor, and the third sensor being provided at an end of the arm away from the body, respectively.

18. A method of controlling a movable platform, the method comprising:
obtaining depth information of a scene in a first direction based on a first image captured by a first sensor of the movable platform and a third image by a third sensor of the movable platform, respectively;
obtaining depth information of a scene in a second direction based on a second image captured by a second sensor of the movable platform and the third image by the third sensor of the movable platform, respectively; and
controlling movement of the movable platform in space based on the depth information of the scene in both the first direction and the second direction.
wherein the first sensor, the second sensor and the third sensor are mounted on the movable platform at substantially a same level;
the first sensor has a first overlapping field of view with the third sensor to form a first binocular system to observe the scene in the first direction of the movable platform; and
the second sensor has a second overlapping field of view with the third sensor to form a second binocular system to observe the scene in the second direction of the movable platform; the first direction being different from the second direction.

19. The method according to claim 18, further comprising:
obtaining the depth information of the scene in the first direction from a plurality of images captured by the first sensor at different positions as a monocular system and/or a plurality of images captured by the third sensor at different positions as a monocular system.

20. The method according to claim 18, further comprising:
obtaining depth information of a scene above the movable platform based on an image captured by a binocular sensor mounted on the movable platform,
wherein the binocular sensor is configured to face upward of the movable platform when the movable platform moves.
